(19) United States
(12) Patent Application Publication
(10) Pub. No.: US 2015/0222212 A1
(43) Pub. Date: Aug. 6, 2015

(54) ELECTRIC POWER TOOL

(71) Applicant: HITACHI KOKI CO., LTD., Tokyo (JP)

(72) Inventor: Kazutaka Iwata, Ibaraki (JP)

(73) Assignee: HITACHI KOKI CO., LTD., Tokyo (JP)

(21) Appl. No.: 14/420,353

(22) PCT Filed: Sep. 27, 2013
(86) PCT No.: PCT/JP2013/077017

§ 371 Date: Feb. 7, 2015

(30) Foreign Application Priority Data
Sep. 28, 2012 (JP) 2012-215521

(51) Int. Cl. H02P 7/28

(52) U.S. Cl. CPC H02P 7/28

(57) ABSTRACT

An electric power tool comprising a voltage conversion circuit configured to control magnitude of a voltage applied to a motor in accordance with magnitude of load.

### TECHNICAL FIELD

The present invention relates to an electric power tool provided with a voltage conversion circuit of a DC-DC converter and the like.

### BACKGROUND ART

In an electric power tool such as a driver drill and the like, as shown in JP-A-2009-12153, it is common for a controller of a microcomputer or the like to control a motor in accordance with a user's pulling rate of a trigger. As shown in JP-A- 2011-92178, an electric-powered brush cutter, which is operated with the power of a battery, is possible to operate at a sufficiently high rotational speed even with a battery having a small capacity using a booster circuit. When performing screw-fastening or the like with an electric power tool that runs by the battery voltage, it is possible to rotate a motor at a high rotational speed by boosting the battery voltage, thereby increasing the fastening speed.

In the final stage of the screw fastening, the rotational speed is reduced because torque of the motor is increased. Since there is a limit to an output power of a power source, when the voltage of the power source is boosted, a current available to the motor is reduced and the final fastening torque is reduced accordingly.

### SUMMARY OF THE INVENTION

The present invention has been made in an effort to solve the above-described problems, and an object of the present invention is to provide an electric power tool that is provided therein with a voltage conversion circuit and that is capable of increasing its torque in the event of heavy load as compared with a case of uniformly maintaining a voltage applied to a motor regardless of the magnitude of load.

The present invention provides the following arrangements:

(1) An electric power tool comprising a voltage conversion circuit configured to control magnitude of a voltage applied to a motor in accordance with magnitude of load.

(2) The electric power tool according to (1), wherein the voltage conversion circuit controls the magnitude of the voltage applied to the motor to be low when the load is large, and controls the magnitude of the voltage applied to the motor to be high when the load is small.

(3) The electric power tool according to (2), wherein more than one thresholds of the load that are a boundary for switching a level of the voltage applied to the motor are set in the voltage conversion circuit.

(4) The electric power tool according to anyone of (1) to (3), wherein the voltage conversion circuit controls the voltage applied to the motor in accordance with an operation amount of an input unit.

(5) The electric power tool according to (4), wherein the voltage conversion circuit controls the voltage applied to the motor to be high when the operation amount is large and controls the voltage applied to the motor to be low when the operation amount is small.

(6) The electric power tool according to (4) or (5), wherein the voltage applied to the motor is supplied at a duty cycle of 100% regardless of the operation amount.

(7) The electric power tool according to (1) further comprising:
a body configured to accommodate the motor;
a handle portion extending from the body and configured to accommodate the voltage conversion circuit.

(8) The electric power tool according to (7), wherein
the handle portion includes a grasping portion configured to be grasped by a user, and a battery connection portion provided at one end of the grasping portion, and
the battery connection portion is configured to be connected to a battery, and accommodates the voltage conversion circuit.

(9) An electric power tool comprising:
a motor;
a voltage conversion circuit configured to control magnitude of a voltage applied to a motor;
a processor; and
memory storing computer readable instructions, when executed by the processor, causing the processor to:
detect current flowing in the motor;
control the voltage conversion circuit to control magnitude of voltage applied to the motor in accordance with the current flowing in the motor.

(10) The electric power tool comprising according to (9), wherein the processor executing the computer readable instructions controls the voltage conversion circuit to control the magnitude of the voltage to be low when the current is high, and controls the voltage conversion circuit to control the magnitude of the voltage to be high when the current is low.

In addition, it will be appreciated by those skilled in the art that any combination of the aforementioned structural elements, any conversion in terms of method or system or the like may be effective as another aspect of the present invention.

According to the present invention, it is possible to realize an electric power tool provided with a voltage conversion circuit and capable of increasing its torque in the event of heavy load as compared to a case where voltage applied to a motor is uniformly maintained regardless of the magnitude of load.

### BRIEF DESCRIPTION OF THE DRAWINGS

FIG. 1 is a block diagram showing an electric power tool according to a first embodiment of the present invention.

FIG. 2 is an exemplary circuit diagram showing a voltage conversion circuit 2 shown in FIG. 1.

FIG. 3 shows a characteristic of a motor 3. (A) of FIG. 3 is a characteristic plot showing the relationship between torque and current of a motor 3. (B) of FIG. 3 is a first characteristic plot showing the relationship between current flowing in the motor 3 and voltage (output voltage of voltage conversion circuit 2) applied to the motor 3 in the case of the application of control according to the embodiment. (C) of FIG. 3 is a characteristic plot showing the relationship between rotational speed of the motor 3 and current flowing in the motor 3 in the case of the application of control shown in (B) of FIG. 3.

FIG. 4 shows a characteristic of a motor 3. (A) of FIG. 4 is a characteristic plot showing the relationship between current and torque of the motor 3. (B) of FIG. 4 is a second characteristic plot showing the relationship between current flowing in the motor 3 and voltage (output voltage of voltage conversion circuit 2) applied to the motor 3 in the case of the application of control according to the embodiment. (C) of FIG. 4 is a characteristic plot showing the relationship between rotational speed of the motor 3 and current flowing in the motor 3 in the case of the application of control shown in (B) of FIG. 4.

FIG. 5 is a block diagram showing an electric power tool according to a second embodiment of the present invention.

FIG. 6 is a view showing an overall structure of the electric power tool.

### DETAILED DESCRIPTION OF EXEMPLARY EMBODIMENTS

Hereinafter, exemplary embodiments of the present invention will be described with reference to the accompanying drawings. Like components, members and the like shown in each figure will be designated with like symbols and appropriately repeated descriptions will be omitted. It will be understood that those exemplary embodiments are not intended to limit the invention, but rather to be exemplified. All of the features or the combinations described according to the embodiments are not necessarily included within the entail spirit of the invention.

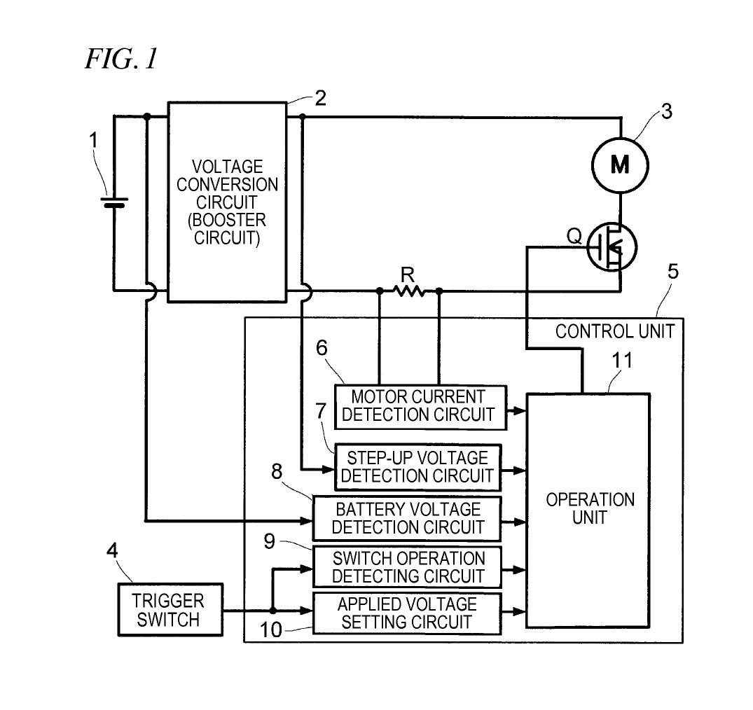

FIG. 1 is a block diagram of the electric power tool according to the first embodiment of the present invention. The kind of an electric power tool may include, for example, an electric-powered driver performing a screw fastening, but is not particularly limited thereto. Further, the mechanical structure of an electric power tool will not be described here since it may be well known. As shown in FIG. 1, the electric power tool is powered by the power of a battery 1 and boosts a voltage of the battery 1 through a voltage conversion circuit 2 to thereby supply the boosted voltage to a motor 3.

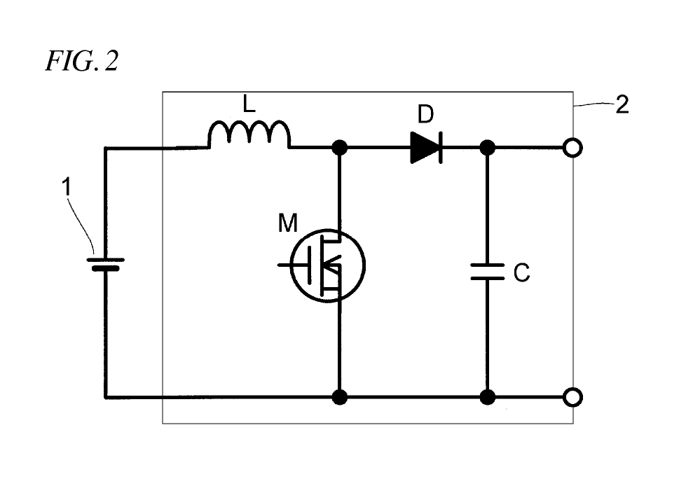

The voltage conversion circuit 2 is a chopper type of DC-DC converter (boost converter), i.e., a booster circuit, for example, as shown in FIG. 2. The voltage conversion circuit 2 serves to add the energy accumulated in a choke coil L to the voltage of the battery 1 by switching control of a switching device M to output the result. A control unit 5 serves to carry out the switching control of the switching device M according to a step-up rate (boost target voltage) while monitoring the output voltage of the voltage conversion circuit 2. A diode D prevents backflow of current, a smoothing capacitor C serves to suppress the variation of the output voltage. The control unit 5 includes a processor and a memory which stores a program for performing the following processing. Alternatively, the control unit 5 may be a ASIC (Application Specific Integrated Circuit) for performing the following processing.

A motor 3 in this embodiment is a brush motor. A resistance R and switching device Q is provided in series with the motor 3. The switching device Q is on/off controlled by the control unit 5. The resistance R is provided for converting a current flowing through the motor 3 into a voltage. A trigger switch 4 is operated by a user which is illustrative of an input unit. The control unit 5 controls the operation of the motor 3. The details of the control will be described later.

In the control unit 5, the motor current detecting circuit 6 detects the current flowing in the motor 3 based on the terminal voltage of the resistance R to transmit it to the operation unit 11. The step-up voltage detection circuit 7 detects the output voltage of the voltage conversion circuit 2 to transmit it to the operation unit 11. The battery voltage detection circuit 8 detects the output voltage of the battery 1 to transmit it to the operation 11. The switch operation detecting circuit 9 detects the operation of the trigger switch 4 and activates the control unit 5. The applied voltage setting circuit 10 detects an operation amount of the trigger switch 4 to transmit it to the operation unit 11. The operation unit 11 performs various operations necessary for controlling the motor 3. The operation unit 11 is realized by the combination of hardware and software.

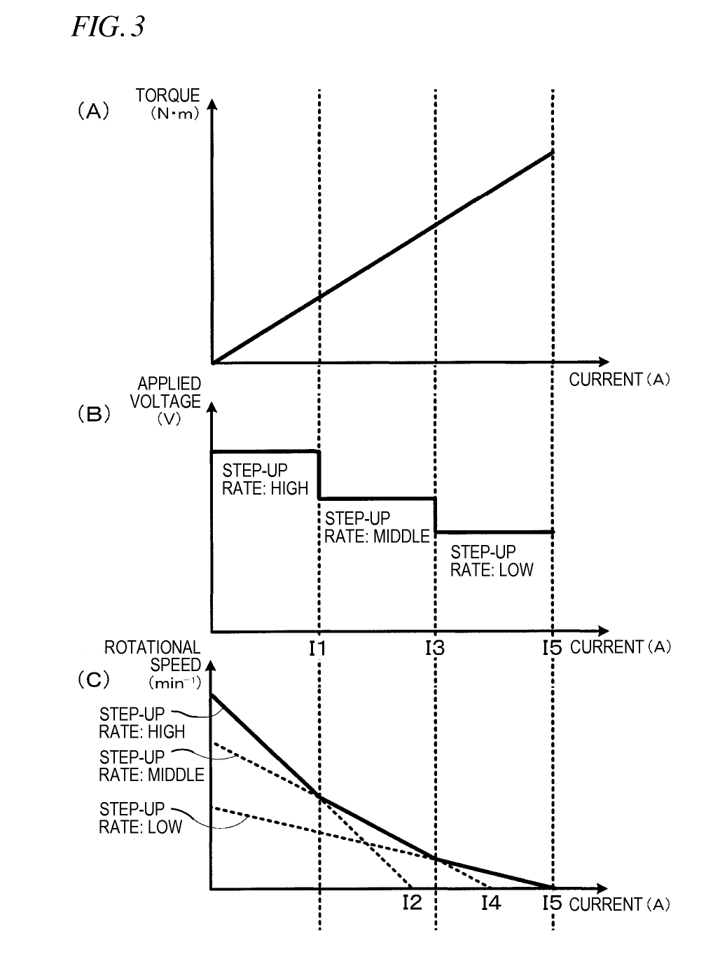

(A) of FIG. 3 is a characteristic plot showing the relationship between the current and torque of the motor 3. As shown in the figure, the current and torque of the motor 3 are proportional to each other. (B) of FIG. 3 is a characteristic plot showing the relationship between the applied voltage to the motor 3 (the output voltage of the voltage conversion circuit 2) and the current flowing through the motor in the case of the control according to the present embodiment. (C) of FIG. 3 is a characteristic plot showing the relationship between the current flowing through the motor 3 and the rotational speed of the motor 3 in the case of the control shown in (B) of FIG. 3. In the (B) and (C) of FIG. 3, the operation amount of the trigger switch 4 is maintained at a constant state, and the duty cycle of the voltage applied to the gate (control terminal) of the switching device Q is uniformly maintained (for example, 100%).

As shown in (B) of FIG. 3, the control unit 5 monitors the current flowing through the motor 3 and reduces the applied voltage to the motor (reducing the step-up rate of the voltage conversion circuit 2) as the current (load) increases. Further, in (B) of FIG. 3, although the current values (thresholds) that borders a switching level (switching of step-up ratio) of the output voltage of the voltage conversion circuit 2 are exemplified with two values (I1 and I2), the current values (thresholds) of the boundary may be determined with one value, or three values or more.

As is apparent from (C) of FIG. 3, by reducing the step-up rate of the voltage conversion circuit 2 with increasing current (load), the maximum current capable of being supplied to the motor 3 is increased (I5>I4>I3), thereby enabling the torque to increase, which means that it is possible to increase the final fastening torque in the case of screw fastening. Further, in the range between I1 and I3 (I1<I3), the motor 3 can rotate at a higher speed in the case of a middle level rather than a high level in the step-up rate. Likewise, in the range between I3 and I5 (I3<I5), the motor 3 can rotate at a higher speed in the case of a low level rather than a middle level in the step-up rate. Thus, by the application of the control method shown in (B) of FIG. 3, that is, by maintaining the high step-up rate until the current value of the motor 3 is I1, the middle step-up rate in the range between I1 and I3, and the low step-up rate (no boosting) in the range between I3 and I5, it is possible to increase the torque of the motor 3 in the event of heavy loads while the motor 3 rotates at high speed in the event of light loads.

In the control of (B) of FIG. 3, the operation amount of the trigger switch 4 may be reflected by changing the step-up rate (increasing the step-up rate as the operation amount is large). At this time, the current value that is a boundary of switching of the step-up rate may also be changed according to the operation amount of the trigger switch 4. Further, the duty cycle of the applied voltage to the gate (control terminal) of the switching device Q may be controlled in accordance with the operation amount of the trigger switch 4, but the duty cycle of the switching device Q may also be fixed to 100% regardless of the operation amount of the trigger switch 4, thereby it is possible to simplify the circuit by eliminating the need for PWM control of the switching device Q.

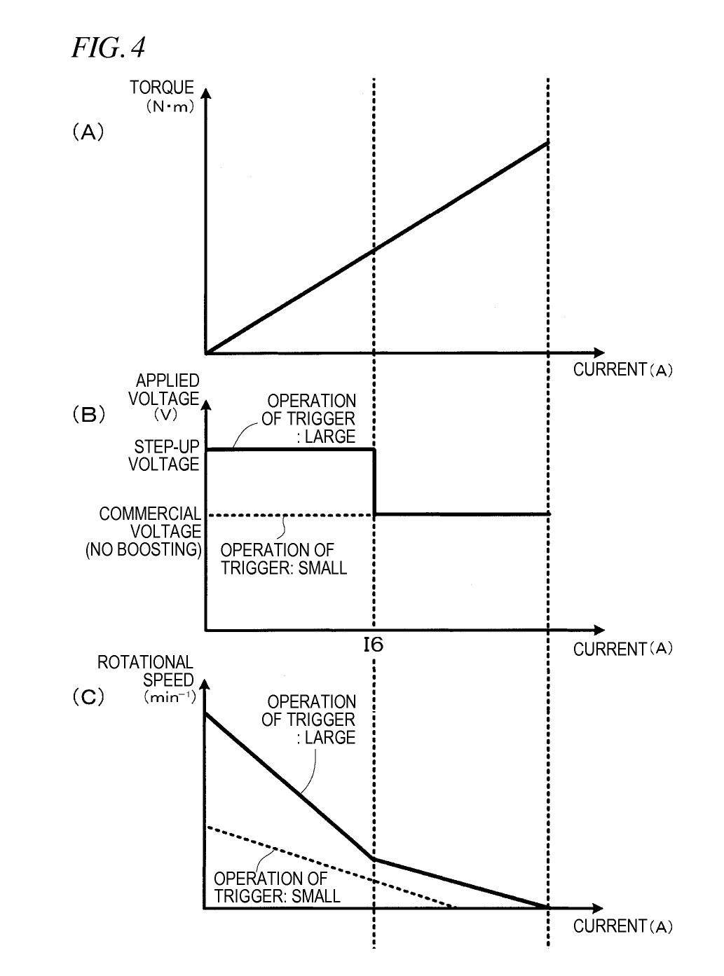

(A) of FIG. 4 is a characteristic plot showing the relationship between the current and torque of the motor 3. The present figure is the same as FIG. 3A. (B) of FIG. 4 is a second characteristic plot showing the relationship between the current flowing through the motor 3 and the voltage (output voltage of voltage conversion circuit 2) applied to the motor 3 in the case of the application of the control according to the embodiment. (C) of FIG. 4 is a characteristic plot showing the relationship between rotational speed of the motor 3 and the current flowing in the motor 3 in the case of applying of the control shown in (B) of FIG. 4. In the control shown in (B) of FIG. 4, when the operation amount of the trigger switch 4 is large, the control unit 5 operates the voltage conversion circuit 2 to thereby apply the boosted voltage to the motor 3 until the current of the motor 3 is I6, and when the current exceeds I6, it applies the voltage of the battery 1 to the motor 3 without performing boosting of voltage by the voltage conversion circuit 2. On the other hand, when the operation amount of the trigger switch 4 is small, the control unit 5 applies the voltage of the battery 1 to the motor 3 without performing boosting of voltage by the voltage conversion circuit 2 regardless of the current flowing through the motor 3. According to such control, it is possible to prevent an abrupt change in the rotational speed and it is easy to control the rotational speed as compared with the case to always operating the voltage conversion circuit 2 regardless of the operation amount of the trigger switch 4. When the operation amount of the trigger switch 4 is middle, it is preferable to make the boost voltage smaller than in the case of being large. Further, the characteristic of (C) of FIG. 4 shows that the duty cycle of the switching device Q is also varied depending on the operation amount of the trigger switch 4 (if the operation amount of the trigger switch 4 is small, the duty cycle is also small).

According to the present embodiment, it is possible to achieve the following effects.

(1) Since the step-up rate of the voltage conversion circuit 2 is reduced as the current (load) of the motor 3 increases, the current that can be supplied to the motor 3 in the event of heavy load may be increased. Therefore, it is possible to make the torque large as compared with the case where the step-up rate of the voltage conversion circuit 2 is uniformly maintained regardless of the magnitude of the current of the motor 3.

(2) Since boosting of voltage by the voltage conversion circuit 2 is not performed when the operation amount of the trigger switch 4 is small, it is easy to control the rotational speed and it is possible to prevent an abrupt change in the rotational speed, compared with the case where the voltage conversion circuit 2 is always operated regardless of the operation amount of the trigger switch 4.

(3) Since the step-up rate of the voltage conversion circuit 2 is changed according to the operation amount of the trigger switch 4, the duty cycle of the switching device Q can be maintained uniformly at 100% regardless of the operation amount of the trigger switch 4 and it is thereby possible to simplify the circuit configuration by eliminating the need for the PWM control of the switching device Q.

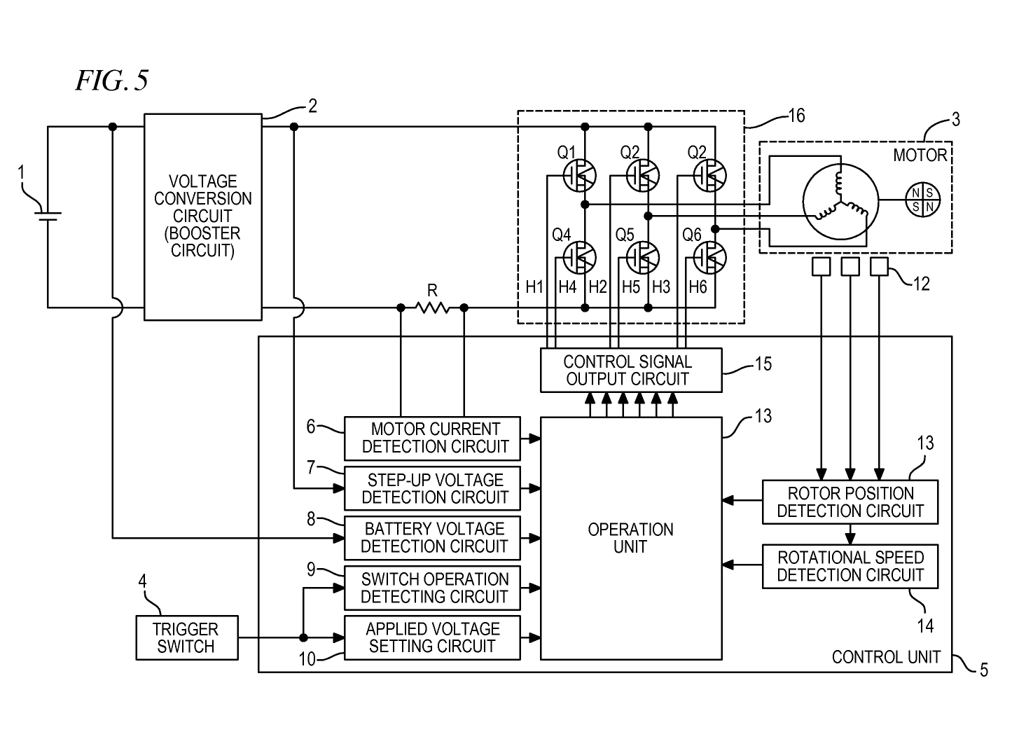

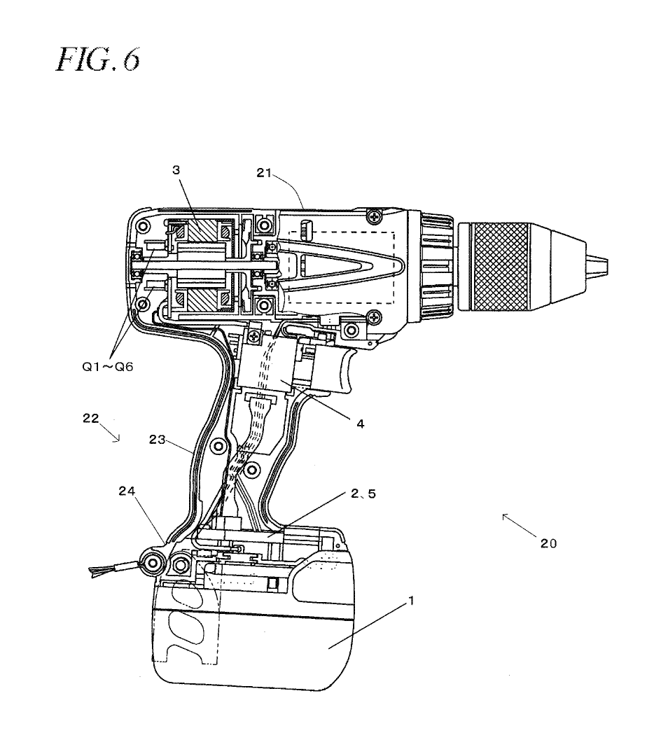

FIG. 5 is a block diagram showing an electric power tool according to a second embodiment of the present invention. FIG. 6 is a view showing an overall structure of the electric power tool 20.

The electric power tool 20 includes a body 21 which accommodates the motor 3 for driving a tool, and a handle portion 22 extending from the body 21. The handle portion 22 includes a grasp portion 23 which is designed so that a user can grasp and a battery connection portion 24 which is configured to be connected to the battery 1 and accommodates the control unit 5 and the voltage conversion circuit 2. The trigger switch 4 is provided at the grasp portion 23 so that the user can operate the trigger switch 4.

Unlike those in the first embodiment shown in FIG. 1, the electric power tool is provided with the motor 3 as a brushless motor. The rotor position detection device 12 is, for example, a magnetic sensing element such as a Hall element. In the control unit 5, the rotor position detection circuit 13 detects the rotational position of the motor 3 based on the output signal of the rotor position detection element 12 to transmit it to the rotational speed detection circuit 14 and the operation unit 11. The rotation speed detection circuit 14 detects the rotational speed of the motor 3 with the output signal of the rotor position detection circuit 13 to transmit it the operation unit 11. The operation unit 11 generates switching device driving signals H1˜H6 applied to switching devices Q1˜Q6 of the inverter circuit 16 on the basis of the position signal from the rotor position detection circuit 13, and inputs those from the control signal output circuit 15 to the gate of switching device Q1˜Q6 (control terminal). The inverter circuit 16 is controlled by the switching device driving signal H1˜H6, thereby converting an output DC voltage of the voltage conversion circuit 2 to an AC voltage to supply it to the motor 3. It is preferred that the switching device driving signals H1˜H6 be PWM signals of the duty cycle corresponding to the operation amount of the trigger switch 4, but, as in the first embodiment, by varying the step-up rate of the voltage conversion circuit 2 in accordance with the operation amount of the trigger switch 4, the duty cycle of the switching device Q may be maintained uniformly at 100% regardless of the operation amount of the trigger switch 4. The other points of the present embodiment are similar to the first embodiment. The present embodiment can also achieve the same effect as the first embodiment.

In the foregoing, although the present invention has been described with reference to certain exemplary embodiments by way of illustration only, but it will be understood by those skilled in the art that various modifications in each component, or each process of the embodiments may be made within the scope of the invention as defined by the appended claims. Hereinafter, exemplary modifications will be described.

The electric power tool is not limited to a DC powered tool, but may be an AC powered tool AC. The voltage conversion circuit 2 is not limited to the boost type (boost converter) that was illustrated in the embodiments, but may be a step-down type (buck converter), or both type (buck-boost converter) in which both of the buck and boost may be possible buck, a transformer to step up or step down a voltage from an AC power source. In any cases, by reducing the voltage applied to the motor 3 as the current (load) of the motor 3 increases, it is possible to make the current supplied to the motor 3 large in the event of heavy loads. Further, although a breaker tends to fall when a plurality of compressors or an AC powered tool is connected to a commercial power source, but by lowering the voltage applied to the motor in the event of heavy loads, it is possible to prevent the breaker from falling.

By making the boost level variable by an operator, the tool may be configured to be changed in the characteristics thereof so that the operator can easily use the tool. In this case, in order to vary the boost level, a button may be provided on a housing of the tool.

Since the DC-DC converter generates heat, a thermistor may be mounted in the vicinity of, for example, a switching device of the DC-DC converter to add high-temperature protection function so that an operation of the tool may be prohibited once the temperature thereof is a certain degree or more.

1. An electric power tool comprising a voltage conversion circuit configured to control magnitude of a voltage applied to a motor in accordance with magnitude of load.

2. The electric power tool according to claim 1, wherein the voltage conversion circuit controls the magnitude of the voltage applied to the motor to be low when the load is large, and controls the magnitude of the voltage applied to the motor to be high when the load is small.

3. The electric power tool according to claim 2, wherein more than one thresholds of the load that are a boundary for switching a level of the voltage applied to the motor are set in the voltage conversion circuit.

4. The electric power tool according to claim 1, wherein the voltage conversion circuit controls the voltage applied to the motor in accordance with an operation amount of an input unit.

5. The electric power tool according to claim 4, wherein the voltage conversion circuit controls the voltage applied to the motor to be high when the operation amount is large and controls the voltage applied to the motor to be low when the operation amount is small.

6. The electric power tool according to claim 4, wherein the voltage applied to the motor is supplied at a duty cycle of 100% regardless of the operation amount.

7. The electric power tool according to claim 1 further comprising:
a body configured to accommodate the motor;
a handle portion extending from the body and configured to accommodate the voltage conversion circuit.

8. The electric power tool according to claim 7, wherein
the handle portion includes a grasping portion configured to be grasped by a user, and a battery connection portion provided at one end of the grasping portion, and
the battery connection portion is configured to be connected to a battery, and accommodates the voltage conversion circuit.

9. An electric power tool comprising:
a motor;
a voltage conversion circuit configured to control magnitude of a voltage applied to a motor;
a processor; and
memory storing computer readable instructions, when executed by the processor, causing the processor to:
detect current flowing in the motor;
control the voltage conversion circuit to control magnitude of voltage applied to the motor in accordance with the current flowing in the motor.

10. The electric power tool comprising according to claim 9, wherein the processor executing the computer readable instructions controls the voltage conversion circuit to control the magnitude of the voltage to be low when the current is high, and controls the voltage conversion circuit to control the magnitude of the voltage to be high when the current is low.
